(19) United States
(12) Patent Application Publication
(10) Pub. No.: US 2025/0339008 A1
(43) Pub. Date: Nov. 6, 2025

(54) DOCKING APPARATUS

(71) Applicants: Hyundai Motor Company, Seoul (KR); Kia, Corporation, Seoul (KR)

(72) Inventors: Jae Seung LEE, Hwaseong-si (KR); JIN HO HWANG, Cheonan-si (KR); Won KI SONG, Seongnam-Si (KR); Hyung Sik CHOI, Seoul (KR)

(73) Assignees: Hyundai Motor Company, Seoul (KR); Kia Corporation, Seoul (KR)

(21) Appl. No.: 18/931,385

(22) Filed: Oct. 30, 2024

(30) Foreign Application Priority Data
May 3, 2024 (KR) 10-2024-0059346

(51) Int. Cl. A47L 9/28

(52) U.S. Cl. CPC A47L 9/2873; A47L 2201/02

(57) ABSTRACT

A docking apparatus is configured for maintaining a strong docking state by combining magnetic fixation and physical connection when docking different components and preventing gaps in various directions, including up, down, left, and right, while in the docked state, ensuring the durability and quality of each component.

### CROSS REFERENCE TO RELATED APPLICATION

The present application claims priority to Korean Patent Application No. 10-2024-0059346, filed May 3, 2024, the entire contents of which is incorporated herein for all purposes by this reference.

### BACKGROUND OF THE PRESENT DISCLOSURE

### Field of the Present Disclosure

The present disclosure relates to a docking apparatus configured for maintaining a robust connection state with various electronic devices.

### Description of Related art

In recent times, there has been increasing interest in autonomous mobility devices. Autonomous mobility devices integrate autonomous driving technology for self-navigation, eliminating the demand for user input on movement, direction, or speed. For example, autonomous vehicles, autonomous mobile robots, and robotic vacuum cleaners may be considered autonomous mobility devices, and these devices may be used diversely depending on their intended purpose.

With the diversification of purposes for autonomous mobility devices, docking systems between these devices are also being developed.

For example, autonomous mobility devices can individually provide indoor space, and a plurality of devices can dock together to expand indoor space according to usage needs.

Furthermore, to enhance manufacturing efficiency and versatility, many mobile devices are constructed by assembling a plurality of modules that are fabricated separately.

During the assembly process, it is crucial to ensure both ease of assembly and a robust connection between the modules, as compromised assembly integrity can lead to gaps between components, detachment, and durability issues.

Beyond facilitating assembly, the modular design of mobile devices may also prioritize ease of disassembly for efficient maintenance of individual modules.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a docking apparatus which is configured for maintaining a strong docking state by combining magnetic fixation and physical connection when docking different components and preventing gaps in various directions, including up, down, left, and right, while in the docked state.

In order In various aspects of the present disclosure, a disclosed docking apparatus includes a locking housing including a driving unit and a locking bar of which rotational position changes by operation of the driving unit, and a base including an armature provided with a claw including an insertion section and an engagement section, a first restraint member configured to restrain movement of the locking bar in a first direction when the locking bar moves from the insertion section to the engagement section, and a second restraint member configured to restrain movement of the locking bar in a second direction perpendicular to the first direction.

The locking housing further includes a magnetic member configured, when the locking housing contacts with the armature, to form a magnetic field to magnetically connect the locking housing to the armature.

The driving unit includes a motor including a shaft rotating by rotation force, a driving gear connected to the shaft, a first driven gear gear-engaged with the driving gear and connected to the magnetic member, and a second driven gear gear-engaged with the driving gear and connected to the locking bar.

The magnetic member includes a first permanent magnet rotatably mounted in the locking housing and connected to the first driven gear and a second permanent magnet spaced apart from the first permanent magnet and fixed to the locking housing.

The first restraint member is configured to be movable within the insertion section of the claw and partially overlap with a space between the insertion section and the engagement section.

The first restraint member is supported in the direction opposite to the insertion direction of the locking bar by an elastic member.

The locking bar includes a semi-circular cross-section of which curved portion faces the insertion section when inserted into the claw, and when rotated by the driving unit, faces the engagement section while the flat portion contacts with the first restraint member.

The first restraint member includes a slider, and the armature includes a guiding portion to slidably receive the slider and guide the linear movement of the first restraint member.

The locking bar is formed to extend in the first direction, and the second restraint member is positioned spaced apart from the armature in a longitudinal direction of the locking bar, allowing one end portion of the locking bar to be connected to the second restraint member.

The second restraint member includes a locking recess through which the locking bar passes, and when the locking housing moves in a third direction while the locking bar is inserted into the claw of the armature, the locking bar is inserted into the locking recess.

The locking bar includes a locking portion formed at one end portion of the locking bar, the locking portion being formed to extend radially from one side of the center portion of the locking bar, and the locking recess of the second restraint member is formed to match the locking portion.

The locking housing is moved toward the base, inserting the locking bar into the claw of the armature, and then toward the second restraint member to enter a preparatory state for locking, and when the driving unit operates, the locking bar engages with the claw of the armature and is simultaneously fixed to both the first and second restraint members, resulting in a fixed state where the movement of the locking bar is restricted in the first, second, and third directions.

A docking apparatus, structured as described above, is advantageous in terms of maintaining a strong docking state by combining magnetic fixation and physical connection when docking different components and preventing gaps in various directions, including up, down, left, and right, while in the docked state, ensuring the durability and quality of each component.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a docking apparatus according to an exemplary embodiment of the present disclosure;

FIG. 2 is a cross-sectional view of the docking apparatus of FIG. 1;

FIG. 3 is a diagram illustrating a pre-docking state of a docking apparatus according to according to an exemplary embodiment of the present disclosure;

FIG. 4 is a diagram illustrating the docking process of a docking apparatus according to according to an exemplary embodiment of the present disclosure;

FIG. 5 is a diagram illustrating the docking completion state of a docking apparatus according to according to an exemplary embodiment of the present disclosure;

FIG. 6 is a diagram illustrating an armature and a first restraint member of a docking apparatus according to according to an exemplary embodiment of the present disclosure;

FIG. 7 is a cross-sectional view exemplarily illustrating an armature and a first restraint member of a docking apparatus according to according to an exemplary embodiment of the present disclosure;

FIG. 8 is a diagram illustrating the pre-connection state of a locking bar and a second restraint member in a docking apparatus according to according to an exemplary embodiment of the present disclosure;

FIG. 9 is a diagram illustrating a locking bar and a second restraint member of a docking apparatus according to according to an exemplary embodiment of the present disclosure;

FIG. 10 is a diagram illustrating the connected state of a locking bar and a second restraint member in a docking apparatus according to according to an exemplary embodiment of the present disclosure; and

FIG. 11 is a diagram illustrating the connected state of a locking bar and a second restraint member in a docking apparatus according to according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, descriptions are made of the exemplary embodiments disclosed in the present specification with reference to the accompanying drawings in which the same reference numbers are assigned to refer to the same or like components and redundant description thereof is omitted.

As used in the following description, the suffix “module” and “unit” are granted or used interchangeably in consideration of easiness of description but, by itself, including no distinct meaning or role.

Furthermore, detailed descriptions of well-known technologies related to the exemplary embodiments included in the present specification may be omitted to avoid obscuring the subject matter of the exemplary embodiments included in the present specification. Furthermore, the accompanying drawings are only for easy understanding of the exemplary embodiments included in the present specification and do not limit the technical spirit included herein, and it should be understood that the exemplary embodiments include all changes, equivalents, and substitutes within the spirit and scope of the present disclosure.

As used herein, terms including an ordinal number such as “first” and “second” may be used to describe various components without limiting the components. The terms are used only for distinguishing one component from another component.

It will be understood that when a component is referred to as being “connected to” or “coupled to” another component, it may be directly connected or coupled to the other component or intervening component may be present. In contrast, when a component is referred to as being “directly connected to” or “directly coupled to” another component, there are no intervening component present.

As used herein, the singular forms are intended to include the plural forms as well, unless the context clearly indicates otherwise.

It will be further understood that the terms “comprises” or “has,” when used in the present specification, specify the presence of a stated feature, number, step, operation, component, element, or a combination thereof, but they do not preclude the presence or addition of one or more other features, numbers, steps, operations, components, elements, or combinations thereof.

For example, each controller may include a communication device communicating with another controller or sensor to control a function in charge, a memory that stores operating system or logic instructions and input/output information, and one or more processors for determination, operation, and decision-making necessary for functions in charge.

Hereinafter, a description includes the docking apparatus according to an exemplary embodiment of the present disclosure with reference to accompanying drawings.

The present disclosure relates to a docking apparatus configured for allowing different components to be assembled or dissembled interchangeably.

That is, the presently disclosed docking apparatus is configured for allowing a plurality of components to be selectively attached and detached according to multiple usage purposes and situations, facilitating the interchangeable docking of different mobility devices, the separately manufacturable and detachable configuration of driving portions and space-providing portions offering indoor space for customizable vehicles, and the connection of buildings and vehicles or buildings. The presently disclosed docking apparatus is configured for being applied in various ways depending on the intended purpose and application field.

The presently disclosed docking apparatus includes a locking housing 100 and a base 200, wherein the locking housing 100 is provided on one component and the base 200 is provided on another component, allowing different components to be docked with each other via the locking housing 100 and the base 200.

That is, the locking housing 100 may be part of the fixed component or configured to be separately mounted on the fixed component, while the base 200 may be part of the counterpart component or separately mounted on the counterpart component.

Additionally, the locking housing 100 and the base 200 may be both provided on each respective component, enabling different components to dock in various directions.

The locking housing 100, provided with an electronically controlled driving unit 110, may be positioned on the component configured for supplying electrical energy, while the base 200, featuring mechanical elements, may be freely provided on the component.

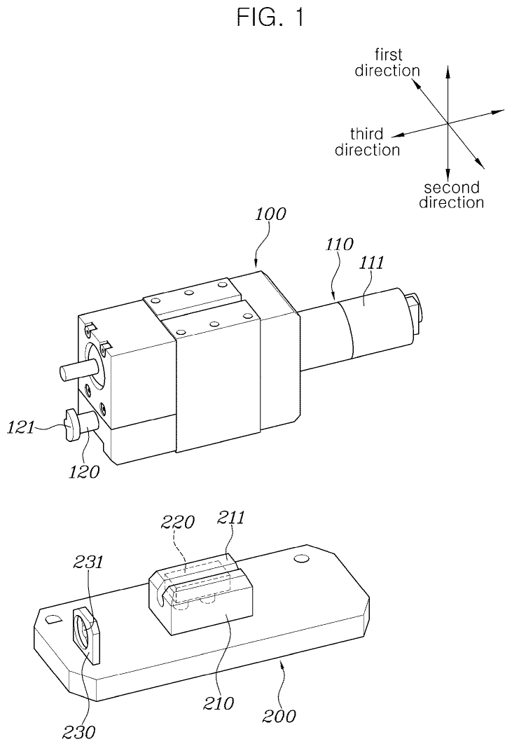

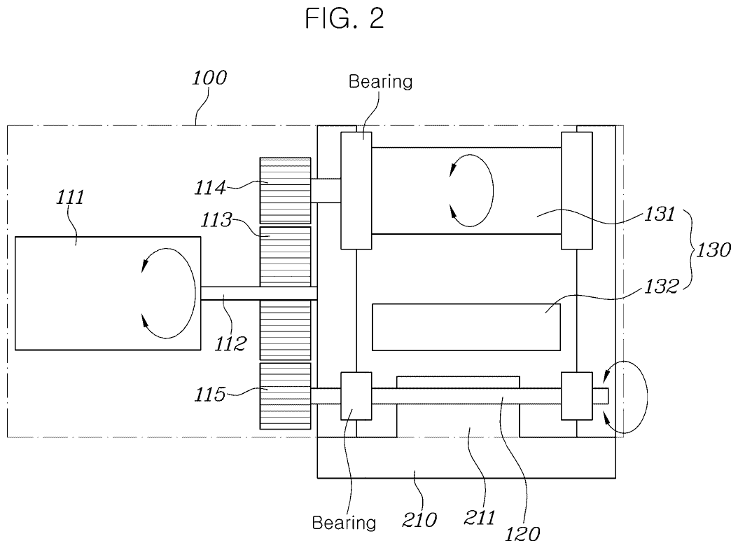

As shown in FIG. 1 and FIG. 2, the locking housing 100 is provided with a driving unit 110 and a locking bar 120 whose rotational position changes by operation of the driving unit 110. The driving unit 110 is configured to generate rotational power, and the locking bar 120 is connected to the driving unit 110 so that the rotational position changes according to the operation of the driving unit 10.

The base 200 includes an armature 210, a first restraint member 220, and a second restraint member 230.

The armature 210 is provided with a claw 211, which forms an insertion section 211a and an engagement section 211b that are spaced apart each other, allowing the locking bar 120 to be inserted between the insertion section 211a and the engagement section 211b. The insertion section 211a in the claw 211 may be formed to extend linearly, and the engagement section 211b may be formed with an end portion bent toward the insertion section 211a. In the present configuration, when the locking bar 120 is inserted on a side of the insertion section 211a and moved toward the engagement section 211b side, the locking bar 120 engages with the claw 211.

Furthermore, when the locking bar 120 is positioned to engage with the claw 211 on the base 200, movement of the locking bar 120 is restricted by the first restraint member 220 and the second restraint member 230. That is, to prevent play and potential disengagement from the claw 211 due to external force with engagement alone, the present disclosure restricts the movement of the locking bar 120 using the first restraint member 220 and the second restraint member 230.

In the present way, when the locking housing 100 is connected to the armature 210 of the base 200, with the locking bar 120 engaged with the claw 211 of the armature 210, the movement of the locking bar 120 in the lateral direction, which is the first direction, is restricted by the first restraint member 220, and the movement in the vertical direction, which is the second direction, is restricted by the second restraint member 230, preventing disengagement of the locking bar 120 from the armature 210 and minimizing play between the locking bar 120 and the armature 210.

In an exemplary embodiment of the present disclosure, when the locking housing 100 is connected to the base 200, the locking bar 120 may be further secured by magnetic force in addition to the physical fixation resulting from engagement with the armature 210.

To achieve this, the locking housing 100 further includes a magnetic member 130, which, upon contact of the locking housing 100 with the armature 210, forms a magnetic field to facilitate the connection of the locking housing 100 to the armature 210.

The magnetic member 130 may include either permanent magnets or electromagnets. The presence of the magnetic member 130 within the locking housing 100 generates a magnetic flux, which, when the locking housing 100 comes into contact with the armature 210, directs the magnetic flux through the armature 210, enabling the locking housing 100 and the armature 210 to be magnetically coupled.

In an exemplary embodiment of the present disclosure, the connection between the locking housing 100 and the armature 210 by the magnetic member 130 is configured to be selectively performed, the magnetic member 130 may include a permanent magnet.

When the magnetic member 130 includes an electromagnet, continuous electrical supply is required for the connection between the locking housing 100 and the armature 210 using magnetic force, resulting in continuous power consumption. In an exemplary embodiment of the present disclosure, however, by constructing the magnetic member 130 using a permanent magnet, power consumption is reduced while allowing for the selective connection of the locking housing 100 and the armature 210 through magnetic force.

As shown in FIG. 2, the driving unit 110 may include a motor 111 provided with a shaft 112 that rotates by rotation force, a driving gear 113 coupled to the shaft 112, a first driven gear 114 gear-engaged with the driving gear 113 and connected to the magnetic member 130, and a second driven gear 115 gear-engaged with the driving gear 113 and connected to the locking bar 120.

Accordingly, the driving unit 110 may include a motor 111, a driving gear 113, a first driven gear 114, and a second driven gear 115, enabling both the magnetic fixation of the magnetic member 130 and the physical fixation of the locking bar 120 to be simultaneously performed by a single motor 111.

The motor 111 is provided with a shaft 112 and generates rotational power to rotate the shaft 112. The motor 111 may be controlled by a controller operably connected to the motor 111.

The driving gear 113 is coupled to the shaft 112 and rotates together, and the first and second driven gears 114 and 115 mesh with each other centered on the driving gear 113. The first driven gear 114 is connected to the magnetic member 130, and the second driven gear 115 is connected to the locking bar 120, allowing both the magnetic connection by the magnetic member 130 and the physical connection by the locking bar 120 to be simultaneously performed by the rotation force of the motor 111, which rotates the first driven gear 114 and the second driven gear 115 simultaneously.

The detailed structure of how the magnetic member 130 and the locking bar 120 are secured to the armature 210 through the present driving unit 110 is as follows.

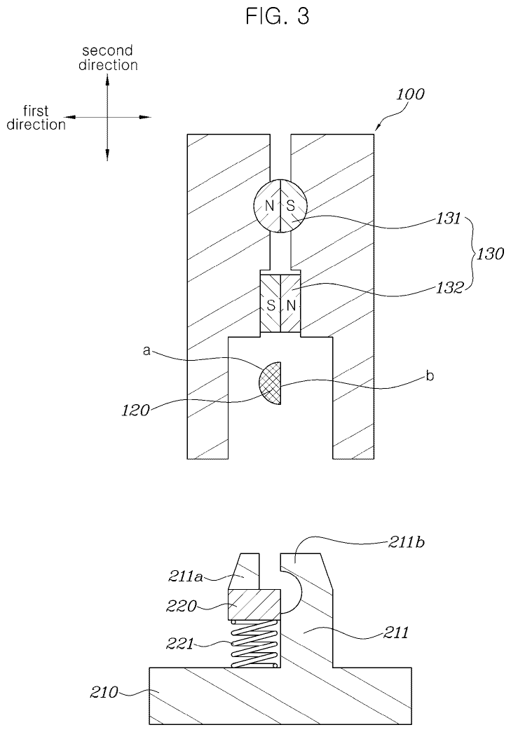

As shown in FIG. 2 and FIG. 3, the magnetic member 130 includes a first permanent magnet 131 rotatably mounted in the locking housing 100 and connected to the first driven gear 114 and a second permanent magnet 132 spaced apart from the first permanent magnet 131 and fixed to the locking housing 100.

Due to the present arrangement, the magnetic flux between the first permanent magnet 131 and the second permanent magnet 132 can vary depending on the rotational position of the first permanent magnet 131, enabling selective engagement of the locking housing 100 with the armature 210 through the variation in magnetic flux.

The rotation of the first permanent magnet 131, enabled by the connection thereof to the first driven gear 114 and rotatable mounting thereof within the locking housing 100, causes the orientation of the N-pole and S-pole contacting with the locking housing 100 to switch. The fixed mounting of the second permanent magnet 132 to the locking housing 100 ensures the constant orientation of N-pole and S-pole thereof.

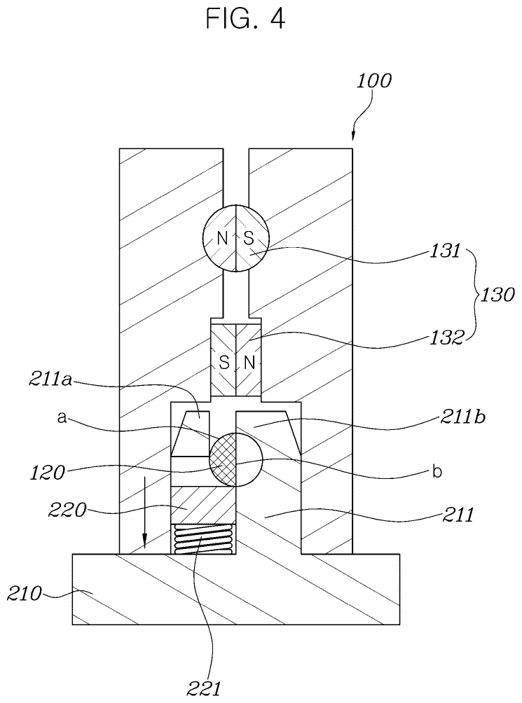

Therefore, when the locking housing 100 comes into contact with the armature 210, in the case where the polarities of the first permanent magnet 131 are disposed to intersect with those of the second permanent magnet 132 as shown in FIG. 4, a magnetic flux is established solely between the first permanent magnet 131 and the second permanent magnet 132 through the locking housing 100. As a result, the locking housing 100 remains disengaged from the armature 210 even in contact with the armature 210.

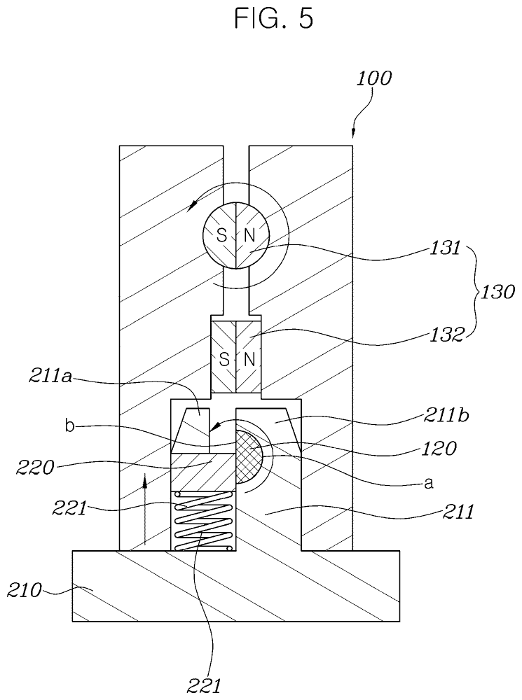

As shown in FIG. 5, when the first permanent magnet 131 is rotated by the motor 111 so that the respective polarities of the first permanent magnet 131 match those of the second permanent magnet 132, the direction of magnetic field formation passes through the armature 210 via the locking housing 100. Consequently, the locking housing 100 may be magnetically engaged with the armature 210.

The locking housing 100 and armature 210 are magnetically engaged solely by adjusting the rotation of the first permanent magnet 131 via motor 111, and the present engagement is maintained passively even when the motor 111 is inactive due to the alignment of polarities, eliminating power consumption for docking maintenance.

Meanwhile, the locking bar 120 includes a semi-circular cross-section, and the claw 211 of the armature 210 features a groove between the insertion section 211a and the engagement section 211b. The claw 211, with the engagement section 211b angled toward the groove, may engage with the locking bar 120, securing the position thereof, when the locking bar 120 is positioned on the engagement section 211b.

As shown in FIG. 4 and FIG. 5, when the locking housing 100 moves toward the armature 210, the locking bar 120 slides along the insertion section 211a of the claw 211 and inserts into the groove of the claw 211, and when the motor 111 operates, the locking bar 120 rotates and moves toward the engagement section 211b of the claw 211, engaging with the claw 211.

In an exemplary embodiment of the present disclosure, simultaneous rotation of the locking bar 120 and the first permanent magnet 131 due to the synchronous rotation of the first driven gear 114 and the second driven gear 115 connected to the driving gear 113 driven by the motor 111 is configured for achieving both physical locking of the locking bar 120 with the claw 211 of the armature 210 and magnetic locking between the first permanent magnet 131 and the second permanent magnet 132, ensuring secure fastening between the locking housing 100 and the base 200.

In an exemplary embodiment of the present disclosure, while the locking bar 120 of the locking housing 100 is engaged with the claw of the armature 210, the first restraint member 220 and the second restraint member 230 restrict the movement of the locking bar 120, ensuring firm locking of the locking bar with the armature 210.

Hereinafter, a description includes the first restraint member 220 in detail.

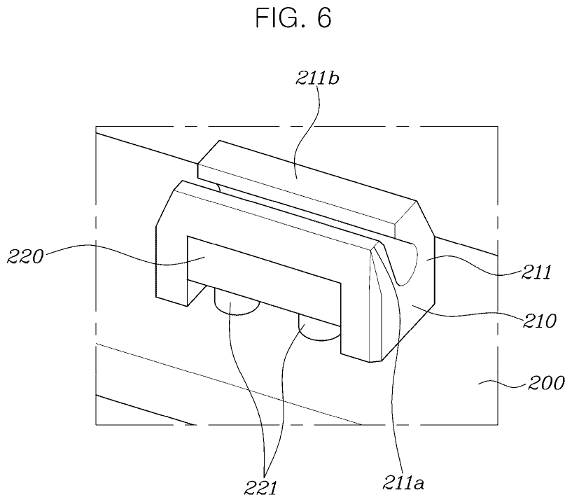

As shown in FIGS. 3 and 6, the first restraint member 220 is designed to be movable within the insertion section 211a of the claw 211 and partially overlap with the space between the insertion section 211a and the engagement section 211b where the locking bar 120 is inserted.

Consequently, a space may be formed in the insertion section 211a of the claw 211 of the armature 210, opening into a groove of the claw 211. Due to the provided configuration, the first restraint member 220 may be internally disposed within the insertion section 211a of the armature 210, and a portion thereof may be exposed between the insertion section 211a and the engagement section 211b of the claw 211.

The first restraint member 220 may be formed to be smaller than the space in the insertion section 211a to allow movement within that space, and the shape and size thereof may be determined so that the first restraint member move in conjunction with the movement of the locking bar 120 upon contact with the locking bar 120. The first restraint member 220, formed in a rectangular block shape and configured for linear movement within the insertion section 211a, may stably secure the locking bar 120 by including the surface thereof come into contact with the surface of the locking bar 120 when the locking bar 120 is moved to the engagement section 211b.

Meanwhile, the first restraint member 220 may be supported in the direction opposite to the insertion direction of the locking bar 120 by an elastic member 221.

The elastic member 221 may include a spring, providing elastic force to allow the first restraint member 220 to return to the original position thereof. Here, the original position of the first restraint member 220 may be toward the extending end portion of the insertion section 211a of the claw 211.

When the locking bar 120 is inserted into the groove of the claw 211 to press the first restraint member 220, the elastic member 221 compresses, and upon release of pressure on the locking bar 120, the elastic member 221 pushes the first restraint member 220 upward, allowing the first restraint member 220 to return to the original position thereof.

Meanwhile, the locking bar 120 is formed with a semi-circular cross-section, and when inserted into the claw 211, the curved portion ‘a’ faces the insertion section 211a, while upon rotation by the driving unit 110, the curved portion ‘a’ faces the engagement section 211b, allowing the flat portion ‘b’ to come into contact with the first restraint member 220.

That is, the claw 211 of the armature 210 features a groove formed between the insertion section 211a and the engagement section 211b, allowing the semi-circular locking bar 120 with the curved portion ‘a’ oriented toward the insertion section 211a to be inserted into the groove along the insertion section 211a.

Here, the locking bar 120 inserted into the claw 211 of the armature 210 becomes engaged with the engagement section 211b of the armature 210 as the curved portion ‘a’ rotates toward the engagement section 211b upon operation of the driving unit 110, while the opposite flat portion ‘b’ comes into contact with the first restraint member 220, restricting the movement of the first restraint member 220 in the first direction thereof.

While other cross-sections are possible, the semi-circular cross-sectional shape of the locking bar 120 enables smooth rotation when inserted into the claw 211, facilitating seamless rotation depending on the operation of the driving unit 110, ensuring clear engagement actions when rotating, whether positioned in the insertion section 211a or the engagement section 211b, and the surface-contact of the flat portion ‘b’ with the first restraint member 220 minimizes play.

Furthermore, a slider 222 may be formed on the first restraint member 220, and a guiding portion 212 may be formed on the armature 210 to receive the slider 222 and guide the linear movement of the first restraint member 220.

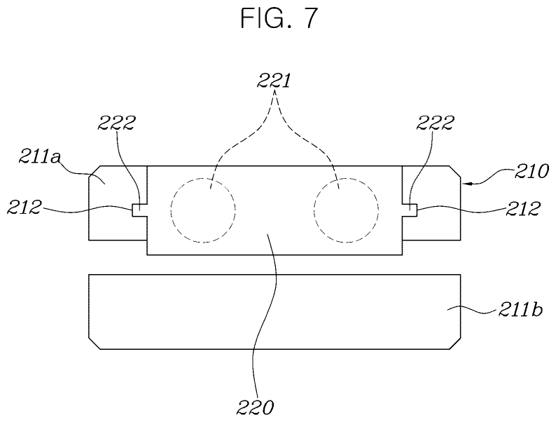

As shown in FIG. 7, the first restraint member 220 may be formed with sliders 222 protruding from both end portions, and the armature 210 may be formed with a groove-shaped guiding portion 212 extending linearly along the length of the insertion section 211a.

Through the present arrangement, the first restraint member 220 is guided by the sliders 222 inserted into the guiding portion 212 of the armature 210, allowing linear movement only in the direction in which the guiding portion 212 extends, preventing detachment from the armature 210.

Hereinafter, a description includes the operation of the first restraint member 220.

In the state where the locking housing 100 is aligned with the armature 210 as shown in FIG. 3, when the locking housing 100 comes into contact with the armature 210 as shown in FIG. 4, the locking bar 120 is inserted into the claw 211 of the armature 210.

In the instant case, the locking bar 120 is inserted into the claw 211 along the insertion section 211a of the armature 210, and as the first restraint member 220 is pressed and moved by the locking bar 120, the locking bar 120 may be fully inserted into the claw 211.

Subsequently, when the driving unit 110 operates and rotates the locking bar 120, the locking bar 120 moves from the insertion section 211a to the engagement section 211b of the claw 211, engaging with the claw 211, and the first restraint member 220, restored to the original position thereof by the elastic member 221, is positioned alongside the locking bar 120. That is, when the locking bar 120 rotates and moves into the engagement section 211b of the claw 211, pressure on the first restraint member 220 is released, and the flat portion ‘b’ faces the insertion section 211a, while the released first restraint member 220 returns to the original position thereof under the influence of the elastic member 221, contacting with the flat portion ‘b’ of the locking bar 120, restricting movement of the locking bar 120 in the first direction thereof.

As a result, the locking bar 120, securely positioned within the claw 211 of the armature 210 and engaged on the engagement section 211b, is constrained by the first restraint member 220, ensuring a robust and stable connection between the locking housing 100 and the base 200.

Hereinafter, a description includes the second restraint member 230 in detail.

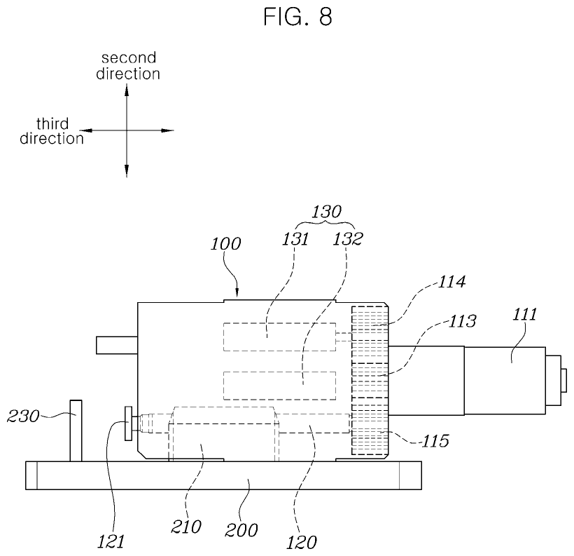

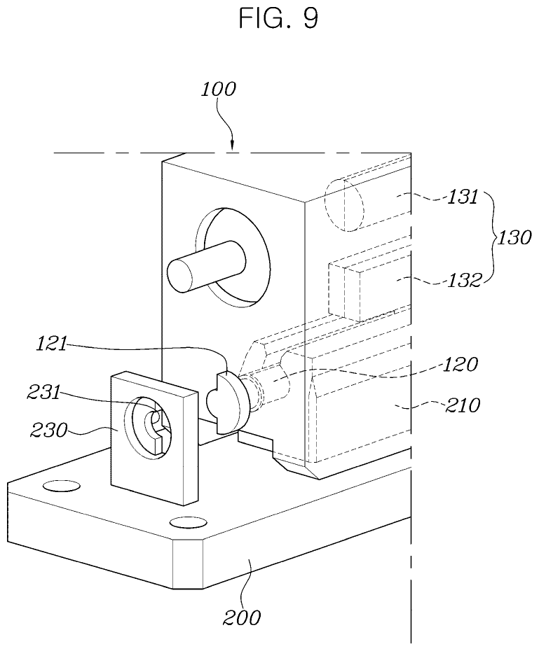

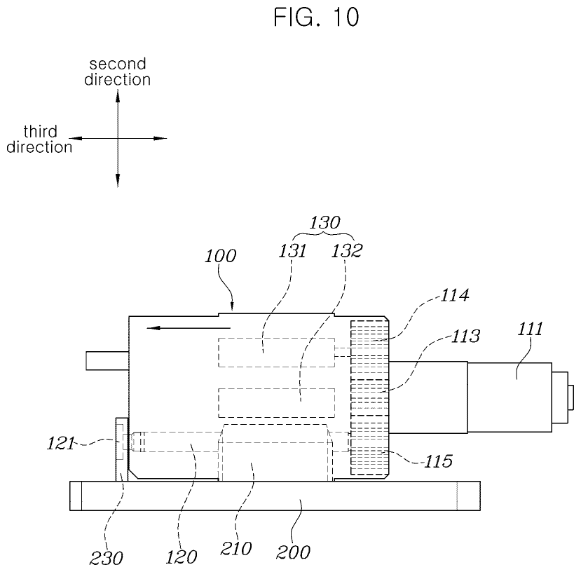

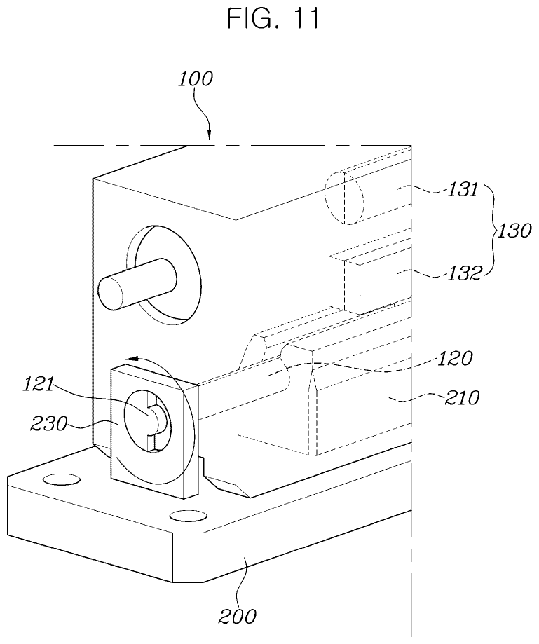

As shown in FIG. 8, FIG. 9, FIG. 10 and FIG. 11, the locking bar 120 is formed to extend in the first direction, and the second restraint member 230 is positioned spaced apart from the armature 210 in the longitudinal direction of the locking bar 120, allowing the end portion of the locking bar 120 to be connected to the second restraint member 230.

In the present manner, the second restraint member 230 is positioned away from the armature 210 in the first direction and may be coupled to the base 200. The present configuration effectively prevents interference between the second restraint member 230 and the locking housing 100 when the locking housing 100 comes into contact with the armature 210.

The locking bar 120 may be designed to extend so that one end portion thereof is connected to the second restraint member 230 when the locking housing 100 moves in the first direction while aligned with the armature 210.

That is, the second restraint member 230 is coupled to the base 200, maintaining the position thereof fixed, while the locking housing 100 is allowed to move in a third direction orthogonal to the first direction while the locking bar 120 is inserted into the claw 211 of the armature 210. Here, the third direction refers to the direction perpendicular to the first direction in a lateral manner, as depicted in FIG. 1 illustrating the first, second, and third directions.

The second restraint member 230 may be configured to be connected to the locking bar 120 when the locking housing 100 is aligned with the armature 210 and moves toward the second restraint member 230 in the third direction thereof.

In detail, the second restraint member 230 includes a locking recess 231 through which the locking bar 120 passes, and when the locking housing 100 moves in the third direction while the locking bar 120 is inserted into the claw 211 of the armature 210, the locking bar 120 is configured for being inserted into the locking recess 231.

The locking bar 120 is provided with a locking portion 121 extending radially from one side of the center portion of the locking bar, and the second restraint member 230 is provided with a locking recess 231 formed to match the locking portion 121.

As shown in FIG. 9, the locking portion 121 is formed at the end portion of the locking bar 120, and the locking recess 231 is formed in the second restraint member 230 for the locking portion 121 to be inserted. Here, the locking portion 121, formed in a fan shape extending radially from one side of the center portion of the locking bar 120, matches with the locking recess 231, allowing the locking portion 121 to pass through the locking recess 231 when the locking bar 120 moves, and during the rotation of the locking bar 120, the locking portion 121 engages with the second restraint member 230, restricting disengagement.

The locking portion 121 and the locking recess 231 may be configured to disengage when the driving unit 110 operates to position the locking bar 120 to engage with the engagement section 211b of the claw 211.

In an exemplary embodiment of the present disclosure, the driving unit 110 operates, causing the locking bar 120 to engage with the claw 211 of the armature 210, magnetically coupling the locking housing 100 and armature 210 via the magnetic member 130, and securing the locking portion 121 of the locking bar 120 to the second restraint member 230 in the state of being passed through the locking recess 231.

As a result, when the locking housing 100 docks with the base 200, a strong docking state may be maintained, minimizing play and thus enhancing overall durability and quality.

The docking procedure for the presently disclosed docking apparatus may be formed as follows.

In the state where the locking housing 100 is aligned with the armature 210 of the base 200 as shown in FIG. 3, when the locking housing 100 moves toward the base 200 as shown in FIG. 4, the locking bar 120 is inserted into the claw 211 of the armature 210. In the instant case, the first restraint member 220 is pressed by the locking bar 120.

As shown in FIG. 10, when the locking housing 100 is moved toward the second restraint member 230, the locking portion 121 of the locking bar 120 passes through the locking recess 231 of the second restraint member 230, wherein the locking bar 120 is rotated by the second driven gear 115 and the driving gear 113 connected to the motor 111.

This state where the locking bar 120 is connected to the claw 211 and the second restraint member 230 may be considered as a preparatory state for locking.

Subsequently, when the driving unit 110 operates, the locking bar 120 rotates and moves into the engagement section 211b of the claw 211, engaging with the claw 211, while simultaneously releasing the pressure exerted by the locking bar 120 on the first restraint member 220, allowing the first restraint member 220 to return to the original position thereof, thus bringing the first restraint member 220 into contact with the side of the locking bar 120. As a result, the locking bar 120 is enclosed and restrained by the claw 211 and the first restraint member 220.

Furthermore, as the locking portion 121 rotates along with the locking bar 120, becoming misaligned with the locking recess 231 of the second restraint member 230, the locking portion 121 engages with the second restraint member 230, preventing the locking housing 100 from moving away from the base 200.

In the present manner, the locking housing 100 is restrained and its movement is restricted by the locking bar 120 engaging with the claw 211 of the armature 210, the first restraint member 220, and the second restraint member 230,

ensuring a strong fixation by constraining movement in the first, second, and third directions.

A docking apparatus, structured as described above, is advantageous in terms of maintaining a strong docking state by combining magnetic fixation and physical connection when docking different components and preventing gaps in various directions, including up, downwards, left, and right, while in the docked state, ensuring the durability and quality of each component.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A docking apparatus comprising:
a locking housing including a driving unit and a locking bar of which rotational position changes by operation of the driving unit coupled to the locking bar; and
a base including:
an armature provided with a claw including an insertion section and an engagement section;
a first restraint member configured to restrain movement of the locking bar in a first direction in response that the locking bar moves from the insertion section to the engagement section; and
a second restraint member configured to restrain movement of the locking bar in a second direction perpendicular to the first direction.

2. The docking apparatus of claim 1, wherein the locking housing further includes a magnetic member configured, in response that the locking housing contacts with the armature, to form a magnetic field to magnetically connect the locking housing to the armature.

3. The docking apparatus of claim 2, wherein the driving unit includes:
a motor including a shaft rotating by rotation force;
a driving gear connected to the shaft;
a first driven gear gear-engaged with the driving gear and connected to the magnetic member; and
a second driven gear gear-engaged with the driving gear and connected to the locking bar.

4. The docking apparatus of claim 3, wherein the magnetic member includes:
a first permanent magnet rotatably mounted in the locking housing and connected to the first driven gear; and
a second permanent magnet spaced apart from the first permanent magnet and fixed to the locking housing.

5. The docking apparatus of claim 1, wherein the first restraint member is configured to be movable within the insertion section of the claw and partially overlap with a space between the insertion section and the engagement section.

6. The docking apparatus of claim 5, wherein the first restraint member is supported in a direction opposite to an insertion direction of the locking bar by an elastic member.

7. The docking apparatus of claim 5, wherein the locking bar includes a semi-circular cross-section of which curved portion faces the insertion section in response that the locking bar is inserted into the claw, and in response that the locking bar is rotated by the driving unit, faces the engagement section while a flat portion of the locking bar contacts with the first restraint member.

8. The docking apparatus of claim 5, wherein the first restraint member includes a slider, and the armature includes a guiding portion to slidably receive the slider therein and guide a linear movement of the first restraint member along the guide portion.

9. The docking apparatus of claim 1, wherein the locking bar is formed to extend in the first direction, and the second restraint member is positioned spaced apart from the armature in a longitudinal direction of the locking bar, allowing one end portion of the locking bar to be connected to the second restraint member.

10. The docking apparatus of claim 9, wherein the second restraint member includes a locking recess through which the locking bar passes, and in response that the locking housing moves in a third direction by the driving unit while the locking bar is inserted into the claw of the armature, the locking bar is inserted into the locking recess.

11. The docking apparatus of claim 10, wherein the locking bar includes a locking portion formed at one end portion of the locking bar, the locking portion being formed to extend radially from one side of a center portion of the locking bar, and the locking recess of the second restraint member is formed to match the locking portion.

12. The docking apparatus of claim 1, wherein the locking housing is moved toward the base, inserting the locking bar into the claw of the armature, and then toward the second restraint member to enter a preparatory state for locking, and in response that the driving unit operates, the locking bar engages with the claw of the armature and is simultaneously fixed to both the first and second restraint members, resulting in a fixed state where the movement of the locking bar is restricted in the first direction, the second direction, and a third directions.

13. A docking apparatus comprising:
a locking housing including a driving unit and a locking bar of which rotational position changes by operation of the driving unit coupled to the locking bar; and
a base including:
an armature provided with a claw including an insertion section and an engagement section;
a first restraint member configured to restrain movement of the locking bar in a first direction in response that the locking bar moves from the insertion section to the engagement section.

14. The docking apparatus of claim 13, wherein the locking housing further includes a magnetic member configured, in response that the locking housing contacts with the armature, to form a magnetic field to magnetically connect the locking housing to the armature.

15. The docking apparatus of claim 14, wherein the driving unit includes:
a motor including a shaft rotating by rotation force;
a driving gear connected to the shaft;
a first driven gear gear-engaged with the driving gear and connected to the magnetic member; and
a second driven gear gear-engaged with the driving gear and connected to the locking bar.

16. The docking apparatus of claim 14, wherein the magnetic member includes:
a first permanent magnet rotatably mounted in the locking housing and connected to the first driven gear; and
a second permanent magnet spaced apart from the first permanent magnet and fixed to the locking housing.

17. The docking apparatus of claim 13, wherein the first restraint member elastically supported by an elastic member is configured to be movable within the insertion section of the claw.

18. The docking apparatus of claim 17, wherein the locking bar includes a semi-circular cross-section of which curved portion faces the insertion section in response that the locking bar is inserted into the claw, and in response that the locking bar is rotated by the driving unit, faces the engagement section while a flat portion of the locking bar contacts with the first restraint member.

19. The docking apparatus of claim 17, further including:
a second restraint member movable in a second direction by the driving unit, and configured to restrain movement of the locking bar in a third direction perpendicular to the first direction.

20. The docking apparatus of claim 19,
wherein the locking bar includes a locking portion formed at one end portion of the locking bar, and
wherein the second restraint member includes a locking recess through which the locking bar passes, and in response that the locking housing moves in the second direction by the driving unit while the locking bar is inserted into the claw of the armature, the locking portion of the locking bar is inserted into the locking recess.
